(19) United States
(12) Patent Application Publication
(10) Pub. No.: US 2012/0098227 A1
(43) Pub. Date: Apr. 26, 2012

(54) VEHICLE STABILIZATION SYSTEM

(76) Inventors: Christian Von HOLST, Hettenleidelheim (DE); Tobias HEGLER, Baden-Baden (DE); Christof BOGE, Telgte (DE)

(21) Appl. No.: 13/238,681

(22) Filed: Sep. 21, 2011

(30) Foreign Application Priority Data
Oct. 20, 2010 (DE) 10 2010 042 673.3

(51) Int. Cl. B60G 21/055

(52) U.S. Cl. 280/124.106

(57) ABSTRACT

A stabilization system for a motor vehicle, such as an agricultural utility vehicle, includes several spring elements which movably support a vehicle body relative to a vehicle chassis. The system includes a stabilizer bar that extends in the direction of a rocking or pitching movement of the vehicle body. The bar has a first end piece pivotally coupled to the vehicle body and a second end piece pivotally coupled to the chassis. The stabilizer bar has two bar segments that are movable relative to each other in its longitudinal direction. A locking device is operable to prevent to prevent relative movement between the bar segments.

### FIELD OF THE INVENTION

The present disclosure relates to a stabilization system for a motor vehicle.

### BACKGROUND OF THE INVENTION

Such a stabilization system is built, for example, into agricultural tractors of the “6030 Premium” series manufactured by John Deere. The stabilization system known in this respect is a component of a hydraulic cabin suspension in which a driver cabin is arranged by means of rubber bearings or hydraulic spring cylinders movable in the vertical direction relative to a supporting vehicle structure. A Panhard rod constructed as a transverse link is used for the lateral guidance and thus the reduction of a possible rocking movement of the driver cabin, wherein the Panhard rod is connected running between the hydraulic spring cylinders with a first end articulated with an axle funnel of the agricultural tractor and with a second end articulated with the driver cabin. The rigid construction of the Panhard rod here leads to a circular downward and upward movement of the driver cabin and thus to the occurrence of an undesired sideways movement around the rubber bearings or the hydraulic spring cylinders. The shearing forces generated here can lead to premature wear, in particular, of the hydraulic spring cylinders. In addition, the rigid Panhard rod forms a sound bridge that promotes the introduction of structure-borne sound vibrations occurring in the vehicle chassis due to travel into the driver cabin.

Therefore, the task of the present invention is to refine a stabilization system of the type named above to the extent of improvements with respect to its wear and/or sound-transmission behavior.

### SUMMARY

According to an aspect of the present disclosure, a stabilization system for a motor vehicle includes several spring elements which movably support a vehicle body relative to a supporting vehicle structure, such as a chassis. The system also includes as a stabilizer bar that extends in the direction of a rocking and/or pitching movement of the vehicle body. The stabilizer bar has a first end piece pivotally coupled to the vehicle body and a second end piece pivotally coupled to the chassis. The stabilizer bar has two bar segments that are movable relative to each other their longitudinal direction. A locking device is operable to prevent relative motion of the bar segments.

In the unblocked state, the stabilizer bar attempts to changes its length such that a sideways movement of the vehicle body for upward and downward deflection and a transfer of structure-borne sound vibrations occurring due to the travel on the supporting vehicle structure are prevented.

In contrast, if an increased lateral guidance of the vehicle body is desired while driving through a curve or on the road or while traveling over uneven or sloping terrain, then the stabilizer bar can also be moved into its blocked state by corresponding actuation of the locking device. The stabilizer bar then behaves like a conventional, rigid transverse link or Panhard rod.

The motor vehicle may be an agricultural utility vehicle, for example, an agricultural tractor, a harvester, a self-propelled sprayer, or the like.

Advantageously, the locking device has a hydraulic compensation cylinder connecting the bar segments, wherein, for blocking the displacement occurring between the bar segments, a hydraulic compensation volume flow generated in the compensation cylinder can be interrupted by means of a blocking element. The blocking element could have, in particular, an electrically actuatable construction, wherein a control unit arranged in the motor vehicle is used for the electrical actuation of the blocking element.

Whether an interruption of the compensation volume flow and thus a blocking of the locking device by closing the blocking element is necessary is determined by the control unit on the basis of one or more input parameters detected by sensors; for example, a driving-speed parameter vF that represents a driving speed of the motor vehicle derived from rotational speeds n of the wheels, a steering-angle parameter δ that represents a steering angle set on steerable front wheels of the motor vehicle, and/or an acceleration parameter a that represents a transverse and/or longitudinal acceleration on the vehicle body. If the control unit recognizes, through evaluation of the input parameters detected by sensors, vF, δ and/or a, that a driving speed typical for road driving, a steering angle indicating driving through a curve, or a transverse and/or longitudinal accelerating indicating driving over uneven or sloping terrain exists, consequently, for avoiding possible rocking and/or pitching movements, an increased lateral guidance of the vehicle body is desired, then the compensation volume flow for blocking the locking device is interrupted by closing the blocking element. In this connection, it is also conceivable to make a prediction of possible rocking or pitching movements of the vehicle body from the amount of the time change of the steering angle or from the actuation characteristics of a brake pedal and/or gas pedal in the motor vehicle.

In addition, as another input parameter, a spring-path parameter Δs that represents a deflection occurring on the spring elements, could be taken into account. In this way, for identifying displacements leading to pronounced sideways movements of the vehicle body, an interruption of the compensation volume flow and thus a blocking of the locking device by opening the blocking element can be cancelled at least occasionally. In this way, possible overloading of the spring elements due to excessive shearing forces can be reliably prevented.

Advantageously, the compensation cylinder is constructed as a synchronizing cylinder, wherein the blocking element connects a first and second cylinder chamber of the synchronizing cylinder to each other hydraulically. The synchronizing cylinder has a piston separating the two cylinder chambers and also two piston rods of identical cross section arranged on opposite sides of the piston, so that a shifting of the piston leads to changes in volume matching in quantity in the two cylinder chambers, each of which is constructed as an annular space. In terms of a most compact possible and simultaneously robust construction, the blocking element could be a structural component of the piston of the synchronizing cylinder. However, it is also conceivable to arrange the blocking element outside of the synchronizing cylinder, wherein this is connected by means of associated hydraulic lines to the cylinder chambers of the synchronizing cylinder. If the locking device are blocked, then the compensation volume flow, generated in the compensation cylinder for a shifting of the piston is interrupted by closing the blocking element.

Alternatively, the compensation cylinder may be a differential cylinder, wherein the blocking element connects a first and second cylinder chamber of the differential cylinder to each other hydraulically and another blocking element is provided for producing a volume compensation connection between one of the two cylinder chambers and a hydraulic fluid accumulator. The differential cylinder has a piston rod on only one side of the piston. A displacement of the piston therefore leads to changes in volume that are different in quantity in the two cylinder chambers constructed as piston or annular spaces. The difference occurring in this respect is compensated by means of the volume compensation connection, as well as the hydraulic-fluid accumulator attached to this connection. The hydraulic-fluid accumulator could be of a conventional type and could comprise a pressure container that is divided by a pressure-sensitive separating element into first and second work chambers. The first work chamber connects via the additional blocking element to the first or second cylinder chamber, while a pressurized gas in the second work chamber forms a gas spring acting on the separating element. The gas is usually nitrogen or a gaseous nitrogen compound. Alternatively, the hydraulic-fluid accumulator could also have a spring-loaded accumulator construction in which, instead of a gas, a mechanically biased spring element acts on the separating element. Through corresponding selection of the spring constants of the hydraulic-fluid accumulator, a targeted specification of the upward and downward deflection behavior is possible. If the locking device is blocked, then the compensation volume flow generated for a shifting of the piston in the compensation cylinder is interrupted through simultaneous closing of the blocking elements. The two blocking elements could here have structurally identical constructions.

The blocking element comprises a throttle that can be adjusted with respect to its flow resistance. It is possible that the throttle can be switched either in two stages between an open and a closed valve position or else allows a multiple-stage or continuous adjustment of the flow resistance. In the latter case, a targeted influence of the compensation volume flow passing through the throttle and thus a partial blocking of the locking device is possible. The compensation cylinder then works as a vibration absorber with adjustable damping characteristics. In principle, it is also conceivable to form the blocking element as a proportional valve or the like, or else to perform a blocking of the locking device in a purely mechanical way instead of hydraulically

In addition, there is the possibility that the hydraulic compensation volume flow has a hydraulic fluid of variable rheology, wherein the throttle comprises a device for changing the rheological behavior for adjusting the flow resistance. Because the adjustment of the flow resistance is carried out by changing the rheology and thus the flow behavior of the hydraulic fluid and not, for example, conventionally in a mechanical way, the throttle works largely without wear.

The hydraulic fluid of variable rheology can involve, in particular, a magneto-rheological fluid. In comparison to the technically related group of electro-rheological fluids—this hydraulic fluid distinguishes itself through improved force-absorbing capabilities. The composition and also the behavior of such fluids are known from the technical literature.

The rheological change in the hydraulic fluid is carried out, in particular, in the region of a passage channel determining the flow resistance of the throttle. For this purpose, a magnetic field can be generated in the region of the passage channel of the throttle by means of the device for changing the rheological behavior. Through corresponding selection of the geometry of the passage channel and also the rheological properties of the hydraulic fluid being used, a targeted influence of the flow resistance in the entire adjustment range of the throttle is possible. The passage channel could have, for example, the form of a tapering or narrowing formed in the throttle.

To guarantee a reliable interruption of the compensation volume flow also for forces acting on the stabilizer bar due to operation, the flow resistance of the throttle must be sufficiently high in its closed valve position. An especially high flow resistance can then be achieved if a magnetic field that is oriented essentially perpendicular to the profile of the passage channel and thus to the chaining direction of the particles in the magneto-rheological fluid can be generated by means of the device for changing the rheological behavior.

The device for changing the rheological behavior could involve, in particular, a magnetic-coil arrangement formed as a structural component of the throttle. The magnetic-coil arrangement comprises, for example, a magnetic coil wound around a ferromagnetic core. The magnetic coil and/or its ferromagnetic core advantageously open into the throttle in the direct vicinity of the passage channel.

Typically, the supporting vehicle structure involves a vehicle chassis and the vehicle body involves a driver cabin. However, it is also conceivable that the spring elements are arranged between a rigid axle as a supporting vehicle structure and the vehicle chassis. The spring elements themselves are formed, in particular, as rubber bearings, mechanical suspension struts, and/or hydraulic spring cylinders, wherein the latter could be components of a hydraulic device present in the motor vehicle for regulating the position or level of the vehicle body.

### BRIEF DESCRIPTION OF THE DRAWINGS

FIG. 1 is a schematic view of a stabilization system for a motor vehicle embodying the invention;

FIG. 2 is a sectional view of first embodiment of a locking device of the stabilization system of FIG. 1; and

FIG. 3 is a sectional view of second embodiment of a locking device of the stabilization system of FIG. 1.

### DETAILED DESCRIPTION OF THE DRAWINGS

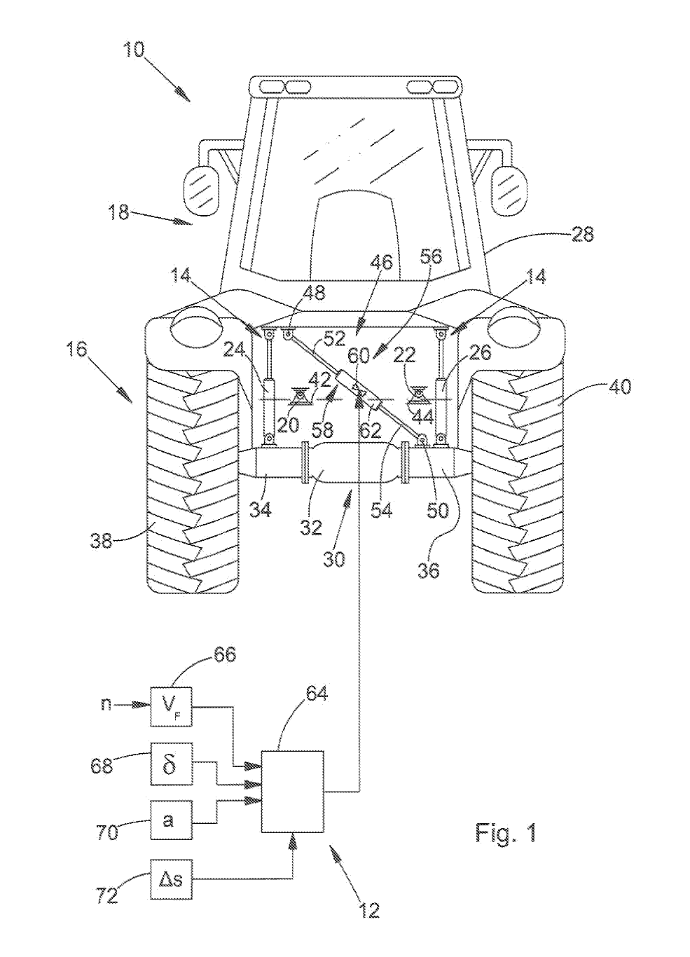

Referring to FIG. 1, a stabilization system 12 is provided for a motor vehicle, such as an agricultural utility vehicle in the form of an agricultural tractor.

The stabilization system 12 includes a plurality of spring elements 14 which movably suspend a vehicle body 18 relative to a supporting vehicle structure or chassis 16. The spring elements 14 formed as rubber bearings 20, 22 or hydraulic spring cylinders 24, 26 support the vehicle body 18 in a front or rear region relative to the supporting vehicle structure 16. The hydraulic spring cylinders 24, 26 are part of a hydraulic device in the tractor 10 for regulating the position or level of the vehicle body 18 formed as a driver cabin 28.

The supporting vehicle structure 16 is a frame-less vehicle chassis 30. The vehicle chassis 30 has a differential housing 32 that is arranged in the rear region of the agricultural tractor 10 and is connected by means of associated final-drive units 34, 36 to the driven rear wheels 38, 40. The hydraulic spring cylinders 24, 26 are pivotally coupled in the region of the final-drive units 34, 36 of the vehicle chassis 30. Additional support points 42, 44 are used for attaching the rubber bearings 20, 22 on the vehicle chassis 30.

The stabilization system 12 also includes a stabilizer bar 46 that extends in the direction of a rocking and/or pitching movement of the driver cabin 28. The bar 46 has a first end piece 48 pivotally coupled to the driver cabin 28 and a second end piece 50 pivotally coupled to the vehicle chassis 30. The stabilizer bar 46 has two bar segments 52, 54 that are movable relative to each other in their longitudinal direction. A locking device 56 is operable to prevent relative movement between the bar segments 52, 54.

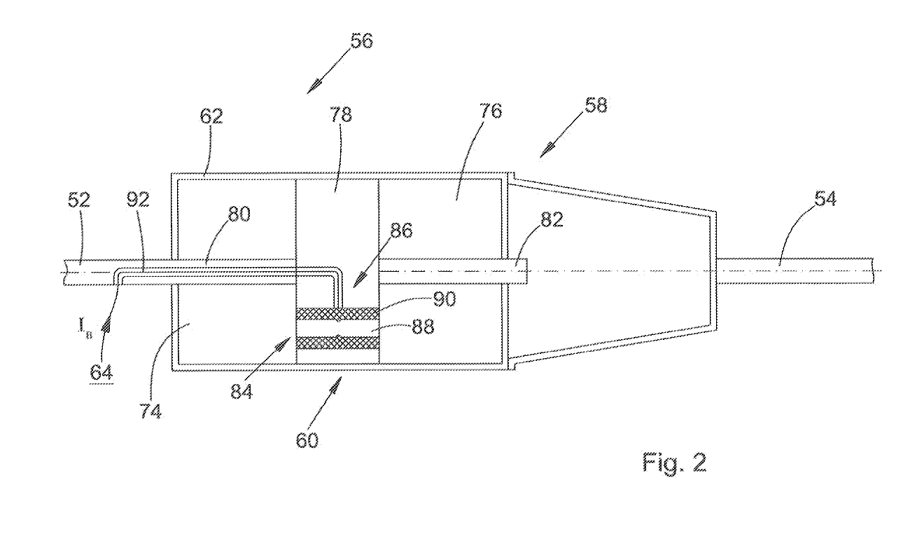

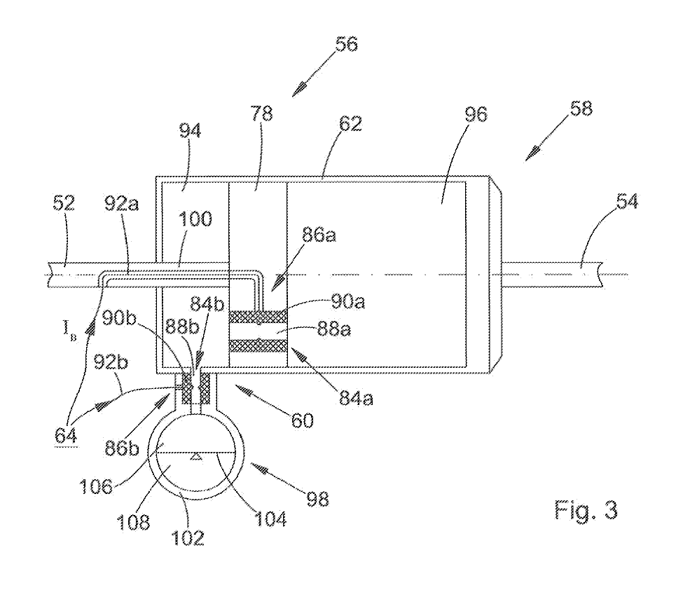

The locking device 56 has a hydraulic compensation cylinder 58 connecting the bar segments 52, 54. A hydraulic compensation volume flow generated in the compensation cylinder 58 can be interrupted by the blocking element 60. More precisely, the first bar segment 52 is connected to a cylinder housing 62 of the compensation cylinder 58, and the second bar segment 54 is connected to a piston arranged movable in the cylinder housing 62. A shifting of the piston can be blocked by the blocking element 60 by interrupting the compensation volume flow. For the exact construction of the compensation cylinder 58 and also of the blocking element 60, at this point refer to the description of the embodiments of the locking device 56 shown in FIGS. 2 and 3.

The blocking element 60 can be actuated electrically by a control unit 64 arranged in the agricultural tractor 10. Whether an interruption of the compensation volume flow and thus a blocking of the locking device 56 by closing the blocking element 60 is required is decided by the control unit 64 on the basis of one or more input parameters detected by sensors, more precisely, a driving-speed parameter vF that is detected by means of wheel-rotational-speed sensors 66 and represents, a driving speed of the agricultural tractor 10 derived from wheel rotational speed n, a steering-angle parameter δ that is detected by means of a steering-angle sensor 68 and represents a steering angle set on steerable front wheels of the agricultural tractor 10, and/or an acceleration parameter a that is detected by means of an acceleration sensor 70 and represents a transverse and/or longitudinal acceleration on the driver cabin 28.

If the control unit 64 identifies, through evaluation of the input parameters vF, δ and/or a, which are detected by sensors, that a driving speed typical for driving on a road, a steering angle indicating driving through a curve, and/or a transverse and/or longitudinal acceleration indicating driving on uneven or sloping terrain exists, consequently an increased lateral guidance of the driver cabin 28 for preventing possible rocking and/or pitching movements is desired, then the compensation volume flow is interrupted for blocking the locking device 56 by closing the blocking element 60.

In addition, the control unit 64 takes into account, as another input parameter, a spring-path parameter Δs that is detected by means of position sensors 72 and represents a displacement occurring on the hydraulic spring cylinders 24, 26. Thus, for identifying displacements leading to pronounced sideways movements of the driver cabin 28, an interruption of the compensation volume flow and thus a blocking of the locking device 56 is cancelled by opening the blocking element 60 at least at some times. In this way, a possible overloading of the rubber bearings 20, 22 or hydraulic spring cylinders 24, 26 due to excessive shearing forces can be reliably prevented.

Referring now to FIG. 2, the compensation cylinder 58 is formed as a synchronizing cylinder, wherein the blocking element 60 connects first and second cylinder chambers 74, 76 of the synchronizing cylinder to each other hydraulically. The synchronizing cylinder has a piston 78 separating the two cylinder chambers 74, 76 and also two piston rods 80, 82 of identical cross section arranged on opposite sides of the piston 78, so that a shifting of the piston 78 leads to changes in volume that match in quantity in the two cylinder chambers 74, 76, each of which is formed as an annular space. In terms of a most compact possible and simultaneously robust construction, the blocking element 60 is a structural component of the piston 78. If the locking device 56 is blocked, then the compensation volume flow generated for a shifting of the piston 78 in the synchronizing cylinder is interrupted by closing the blocking element 60.

The blocking element 60 includes a throttle 84 with an adjustable flow resistance. The hydraulic compensation cylinder 58 contains a hydraulic fluid of variable rheology. The throttle 84 comprises a device 86 for changing the rheological behavior of the fluid. The hydraulic fluid of variable rheology is a magneto-rheological fluid. The composition and also the behavior of such fluids are known from technical literature.

Accordingly, magneto-rheological fluids have magnetically polarized particles that are suspended colloidally in a carrier fluid, typically mineral oil or synthetic oil. The particles typically consist of carbonyl iron with a diameter from 1 to 10 μm. The particles are usually stabilized by means of a polymer surface coating for preventing a trend of undesired sedimentation. If the magneto-rheological fluid is exposed to a magnetic field, then the particles form a chain within the carrier fluid along the field lines and result in an increase in the shear yield stress as a function of the field strength. In this way, the flow behavior of the magneto-rheological fluid can be changed reversibly within a few milliseconds.

The rheological change in the hydraulic fluid is performed in the region of a passage channel 88 determining the flow resistance of the throttle 84. For this purpose, a magnetic field that is oriented essentially perpendicular to the profile of the passage channel 88 and thus to the chaining direction of the particles in the magneto-rheological fluid can be generated in the region of the passage channel 88 of the throttle 84 by means of the device for changing the rheological behavior 86. The passage channel 88 tapers or narrows to form the throttle 84.

The adapting device 86 for changing .the rheological behavior includes a magnetic-coil arrangement 90 formed as a structural component of the throttle 84. The magnetic-coil arrangement 90 comprises a magnetic coil wound about a ferromagnetic core. The magnetic coil and/or its ferromagnetic core open into the throttle 84 in the direct vicinity of the passage channel 88. For blocking the locking device 56, the magnetic coil is charged with a specified control current I_{β} by means of electrical lines 92 connected to the control unit 64. The change in rheological behavior generated in this way leads to a corresponding increase in the flow resistance in the passage channel 88 of the throttle 84 and thus to the interruption of the compensation volume flow. The magnetic field in the region of the passage channel 88 here typically has a field strength on the order of magnitude of 250 to 350 mT.

In other words, the throttle 84 can be switched by turning on and off the control current I_{β} in two stages between an open and a closed valve position. Deviating from this arrangement, however, it is also conceivable for the control current I_{β} to have a variable shape, so that the throttle 84 allows a multiple-stage or continuous adjustment of the flow resistance. In the latter case, a targeted influence of the compensation volume flow passing through the throttle 84 and thus a partial blocking of the locking device 56 is possible. The synchronizing cylinder then works as a vibration absorber with adjustable damping characteristics.

Referring now to FIG. 3, the second embodiment of a locking device differs from the first embodiment of FIG. 2 with respect to the structural form of the compensation cylinder.

In the second embodiment, the compensation cylinder 58 is a differential cylinder, and the blocking element 60a is a throttle 84a which interconnects first and second cylinder chambers 94, 96 of the differential cylinder. Another blocking element 60b or a throttle 84b produces a volume compensation connection between the first cylinder chamber 94 and a hydraulic-fluid accumulator 98. The differential cylinder has a piston rod 100 only on one side of the piston 78. A shifting of the piston 78 therefore leads to different changes in volume in terms of quantity in the two cylinder chambers 94, 96 formed as piston or annular spaces. This difference is compensated for by the volume compensation connection and also the hydraulic-fluid accumulator 98 attached to this connection. The hydraulic-fluid accumulator 98 is of conventional construction and comprises a pressure container 102 that is divided by a pressure-sensitive separating element 104 into first and second work chambers 106, 108. The first work chamber 106 connects via the throttle 84a to the first cylinder chamber 94, while a pressurized gas in the second work chamber 108 forms a gas spring acting on the separating element 104. The gas is nitrogen or a gaseous nitrogen compound. Alternatively, the hydraulic-fluid accumulator 98 could also be formed as a spring-loaded accumulator in which a mechanically biased spring element acts on the separating element 104 instead of a gas. Through corresponding selection of the spring constants of the hydraulic-fluid accumulator 98, a targeted specification of the upward and downward behavior of the differential cylinder is possible. If the locking device 56 is to be blocked, then the compensation volume flow generated in the differential cylinder for a shifting of the piston 78 is interrupted through simultaneous closing of the two throttles 84a, 84b.

The two throttles 84a, 84b have a structurally identical construction and correspond to the throttle 84 described in connection with FIG. 2 with respect to their function. Thus, the throttles 84a, 84b have identical devices for changing the rheological behavior 86a, 86b in the form of corresponding magnetic-coil arrangements 90a, 90b. Each of the magnetic-coil arrangements 90a, 90b comprises a magnetic coil wound about a ferromagnetic core. The magnetic coil and/or its ferromagnetic core open into the throttle 84a, 84b in the direct vicinity of a passage channel 88a, 88b. For blocking the locking device 56, the magnetic coil is charged with a specified control current IB by means of lines 92a, 92b connected to the control unit 64.

While the disclosure has been illustrated and described in detail in the drawings and foregoing description, such illustration and description is to be considered as exemplary and not restrictive in character, it being understood that illustrative embodiments have been shown and described and that all changes and modifications that come within the spirit of the disclosure are desired to be protected. It will be noted that alternative embodiments of the present disclosure may not include all of the features described yet still benefit from at least some of the advantages of such features. Those of ordinary skill in the art may readily devise their own implementations that incorporate one or more of the features of the present disclosure and fall within the spirit and scope of the present invention as defined by the appended claims.

We claim:

1. A motor vehicle stabilization system having a plurality of spring elements for movably suspending a vehicle body relative to a chassis of the vehicle, and having a stabilizer bar which is oriented in a direction of a rocking and/or pitching movement of the vehicle body, the stabilizer bar having a first end piece pivotally coupled to the vehicle body and having a second end piece pivotally coupled to the chassis, characterized by:
the stabilizer bar having two bar segments which are movable relative to each other in a direction of its profile, a locking device for blocking movement of the bar segments relative to each other.

2. The stabilization system of claim 1, wherein:
the locking device comprises a hydraulic cylinder interconnecting the bar segments; and
a blocking element for blocking flow in the cylinder and blocking relative movement between the bar segments.

3. The stabilization system of claim 2, wherein:
the cylinder comprises a synchronizing cylinder, wherein the blocking element controls communication between a first cylinder chamber and a second cylinder chamber.

4. The stabilization system of claim 2, wherein:
the cylinder comprises a differential cylinder; and
the blocking element controls communication between a first cylinder chamber and a second cylinder chamber of the differential cylinder; and
a further blocking element control communication between one of the cylinder chambers and a hydraulic-fluid accumulator.

5. The stabilization system of claim 2, wherein:
the blocking element comprises a throttle having an adjustable flow resistance.

6. The stabilization system of claim 4, wherein:
the further blocking element controls flow of a hydraulic fluid having of variable rheology; and
the blocking element comprises a throttle, the throttle comprising a device for changing the rheological behavior.

7. The stabilization system of claim 6, wherein:
the hydraulic fluid of variable rheology comprises a magneto-rheological fluid.

8. The stabilization system of claim 7, wherein:
an adapting device generates a magnetic field near a passage channel of the throttle in order to change rheological behavior.

9. The stabilization system of claim 7, wherein:
the magnetic field is oriented essentially perpendicular to the profile of the passage channel.

10. The stabilization system of claim 7, wherein:
the adapting device comprises a magnetic-coil arrangement constructed as a structural component of the throttle.

11. The stabilization system of claim 1, wherein:
the supporting vehicle structure comprises a vehicle chassis and the vehicle body comprises a vehicle cab.
